(19) United States
(12) Patent Application Publication
(10) Pub. No.: US 2020/0146300 A1
(43) Pub. Date: May 14, 2020

(54) CROP PATHOGEN CONTROL USING COMPETITIVE PROBIOTIC COMPETITION

(71) Applicant: Van Grow LLC, Longmont, CO (US)

(72) Inventor: Robert Tengler, Longmont, CO (US)

(21) Appl. No.: 16/682,959

(22) Filed: Nov. 13, 2019

Related U.S. Application Data
(60) Provisional application No. 62/760,240, filed on Nov. 13, 2018.

(51) Int. Cl. A01N 63/02

(52) U.S. Cl. CPC A01N 63/02

(57) ABSTRACT

The present invention includes compositions and methods for treating plants or grass for a phytopathogenic microorganism comprising: identifying a plant or grass in need of treatment for Goss or Stewart Wilt; and spraying the plant or grass with a cell suspension, supernatant, filtrate, cell fraction, or whole cell broth derived from a Bacillus amyloliquefaciens and/or Bacillus subtilis, effective to inhibit said phytopathogenic microorganisms such as Clavibacter michiganensis or Pantoea stewartii (Erwinia stewartia).

### CROSS-REFERENCE TO RELATED APPLICATIONS

This application claims priority to U.S. Provisional Application Ser. No. 62/760,240, filed Nov. 13, 2018, the entire contents of which are incorporated herein by reference.

### STATEMENT OF FEDERALLY FUNDED RESEARCH

None.

### TECHNICAL FIELD OF THE INVENTION

The present invention relates in general to the field of crop pathogen control using competitive probiotic competition.

### BACKGROUND OF THE INVENTION

Without limiting the scope of the invention, its background is described in connection with Goss Wilt.

In 2010, the Goss Wilt was a major contributor to the loss of nearly a billion bushels of corn, resulting in a $3.5 billion dollar loss to farmers in the Midwest United States. The estimated mean economic loss due to yield loss by corn diseases in the United States from 2012 to 2015 was $76.51 USD per acre. With average loses of 25% due to Goss Wilt, hundreds of millions of dollars in revenue can be realized with infection control. Goss Wilt infection occurs throughout the world in corn, soybean and other crops, further adding to the overall economic impact to the invention.

Thus, a need remains for methods for preventing, treating, and preventing the spread of infection with Goss or Stewart Wilt.

### SUMMARY OF THE INVENTION

In one embodiment, the present invention includes a method for treating plants, grass, or organism for a phytopathogenic microorganism comprising: identifying a plant or grass in need of treatment for Goss or Stewart Wilt; and spraying the plant or grass with a cell suspension, supernatant, filtrate, cell fraction, or whole cell broth derived from a Bacillus amyloliquefaciens and/or Bacillus subtilis, effective to inhibit said phytopathogenic microorganisms. In one aspect, the cell suspension, supernatant, filtrate, cell fraction, or whole cell broth is a liquid, a gel, is dry, is ground, is extracted from both Bacillus amyloliquefaciens and Bacillus subtilis. In another aspect, the cell suspension, supernatant, filtrate, cell fraction, or whole cell broth is freeze-dried, heat dried, vacuum dried, air-dried, spray-dried and combinations thereof. In another aspect, the method further comprises adding to the cell suspension, supernatant, filtrate, cell fraction, or whole cell broth: a stabilizer, anti-oxidant, a water-repellent, a UV absorbing agent, an anti-microbial agent, a carrier, a diluent, a surfactant, an adjuvant, and combinations thereof. In another aspect, a seed, a plant, a fruit, or a grass is coated in situ with the cell suspension, supernatant, filtrate, cell fraction, or whole cell broth. In another aspect, the cell suspension, supernatant, filtrate, cell fraction, or whole cell broth derived comprises cell content of at least 10⁸ Bacillus amyloliquefaciens and/or Bacillus subtilis per milliliter. In another aspect, the cell suspension, causes plant pathogen suppression by applying low pH organic acids and other anti-pathogen metabolites on either an infected seed and or a whole plant crop in combination with the bacteria, which continues to produce these metabolites. In another aspect, the method further comprises the step of heating the cell suspension, supernatant, filtrate, cell fraction, or whole cell broth prior to application. In another aspect, the plant treated comprises strawberry, squash, cucumber, tomato, rose, pepper eggplant, grapevine, cotton, onion, garlic, wheat, soy, corn and rice.

In another embodiment, the present invention includes a composition pre-treating a plant, grass, or organism against Goss or Stewart Wilt comprising: a cell suspension, supernatant, filtrate, cell fraction, or whole cell broth derived from a Bacillus amyloliquefaciens and/or Bacillus subtilis, effective to inhibit said phytopathogenic microorganisms, wherein the composition is adapted for delivery to the plant or grass and wherein the treated plant or grass has a lower infection rate of Goss or Stewart Wilt than an untreated plant. In one aspect, the cell suspension, supernatant, filtrate, cell fraction, or whole cell broth is a liquid, a gel, is dry, is ground, is extracted from both Bacillus amyloliquefaciens and Bacillus subtilis. In another aspect, the cell suspension, supernatant, filtrate, cell fraction, or whole cell broth is freeze-dried, heat dried, vacuum dried, air-dried, spray-dried and combinations thereof. In another aspect, the composition further comprises: a stabilizer, anti-oxidant, a water-repellent, a UV absorbing agent, an anti-microbial agent, a carrier, a diluent, a surfactant, an adjuvant, or combinations thereof. In another aspect, a seed, a plant, a fruit, or a grass is coated in situ with the cell suspension, supernatant, filtrate, cell fraction, or whole cell broth. In another aspect, the cell suspension, supernatant, filtrate, cell fraction, or whole cell broth derived comprises cell content of at least 10⁸ Bacillus amyloliquefaciens and/or Bacillus subtilis per milliliter. In another aspect, the cell suspension or whole cell broth causes plant pathogen suppression by applying low pH organic acids and other anti-pathogen metabolites on either an infected seed and or a whole plant crop in combination with the bacteria, which continues to produce these metabolites. In another aspect, the cell suspension, supernatant, filtrate, cell fraction, or whole cell broth is heated prior to application. In another aspect, the cell suspension, supernatant, filtrate, cell fraction, or whole cell broth is adapted for administration to strawberry, squash, cucumber, tomato, rose, pepper eggplant, grapevine, cotton, onion, garlic, wheat, soy, corn and rice.

In yet another embodiment, the present invention includes a method for treating a plant or grass with a non-toxic, biodegradable composition comprising: treating the plant with a cell suspension, supernatant, filtrate, cell fraction, or whole cell broth derived from a Bacillus amyloliquefaciens and/or Bacillus subtilis, wherein the composition treats or eliminates a least 10 percent of the effects from Goss or Stewart Wilt when compared to a non-treated plant. In one aspect, the cell suspension, supernatant, filtrate, cell fraction, or whole cell broth is a liquid, a gel, is dry, is ground, is extracted from both Bacillus amyloliquefaciens and Bacillus subtilis. In another aspect, n the cell suspension, supernatant, filtrate, cell fraction, or whole cell broth is freeze-dried, heat dried, vacuum dried, air-dried, spray-dried and combinations thereof. In another aspect, method further comprises adding to the cell suspension, supernatant, filtrate, cell fraction, or whole cell broth: a stabilizer, anti-oxidant, a water-repellent, a UV absorbing agent, an anti-microbial agent, a carrier, a diluent, a surfactant, an adjuvant, and combinations thereof. In another aspect, a seed, a plant, a fruit, or a grass is coated in situ with the cell suspension, supernatant, filtrate, cell fraction, or whole cell broth. In another aspect, the cell suspension, supernatant, filtrate, cell fraction, or whole cell broth derived comprises cell content of at least 10⁸ Bacillus amyloliquefaciens and/or Bacillus subtilis per milliliter. In another aspect, the method further comprises the step of heating the cell suspension, supernatant, filtrate, cell fraction, or whole cell broth prior to application. In another aspect, the plant treated comprises strawberry, squash, cucumber, tomato, rose, pepper eggplant, grapevine, cotton, onion, garlic, wheat, soy, corn and rice. In another aspect, the plant comprises a fruit or vegetable and wherein the fruit or vegetable has an increase in the size and number of fruit or vegetable size, fruit or vegetable number and combinations thereof. In another aspect, the cell suspension or whole cell broth causes plant pathogen suppression by applying low pH organic acids and other anti-pathogen metabolites on either an infected seed and or a whole plant crop in combination with the bacteria, which continues to produce these metabolites.

In another embodiment, the present invention includes a method of inhibiting one or more phytopathogenic microorganisms in a location comprising introducing into the location an amount of a cell suspension, supernatant, filtrate, cell fraction, or whole cell broth derived from a cell suspension, supernatant, filtrate, cell fraction, or whole cell broth derived from a Bacillus amyloliquefaciens and/or Bacillus subtilis, effective to inhibit said phytopathogenic microorganisms; wherein the location is in the soil, seed, or residual organic material and said one or more phytopathogenic microorganisms is Clavibacter michiganensis or Pantoea stewartii (Erwinia stewartia). In another aspect, method further comprises introducing another anti-microbial agent into the location. In another aspect, the location of treatment comprises plant parts. In another aspect, the cell suspension or whole cell broth causes plant pathogen suppression by applying low pH organic acids and other anti-pathogen metabolites on either an infected seed and or a whole plant crop in combination with the bacteria, which continues to produce these metabolites.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the invention, except as outlined in the claims.

As used herein, the term “derived from” refers to directly isolated or obtained from a particular source or alternatively having identifying characteristics of a substance or organism isolated or obtained from a particular source. In the event that the “source” is an organism, “derived from” means that it may be isolated or obtained from the organism itself or from the medium used to culture or grow the organism.

As used herein, the term “whole broth culture” refers to a liquid culture containing both cells and media. If bacteria are grown on a plate the cells can be harvested in water or other liquid, whole culture.

As used herein, the term “supernatant” refers to the liquid remaining when cells that are grown in broth or harvested in another liquid from an agar plate are removed by centrifugation, filtration, sedimentation, or other means well known in the art.

As used herein, the term “filtrate” refers to liquid from a whole broth culture that has passed through a membrane.

As used herein, the term “extract” refers to liquid substance removed from cells by a solvent (water, detergent, buffer) and separated from the cells by centrifugation, filtration or other method.

As used herein, the term “metabolite” refers to a compound, substance or byproduct of a fermentation of a microorganism, or supernatant, filtrate, or extract obtained from a microorganism that has pesticidal and particularly, nematicidal activity.

As defined herein, the term “isolated compound” refers to a formulation that is essentially free of other compounds or substances, e.g., at least about 20% pure, preferably at least about 40% pure, more preferably about 60% pure, even more preferably about 80% pure, most preferably about 90% pure, and even most preferably about 95% pure, as determined by analytical methods, including but not limited to chromatographic methods and electrophoretic methods.

As defined herein, the term “carrier” refers to an inert, organic or inorganic material, with which the active ingredient is mixed or formulated to facilitate its application to plant or other object to be treated, or its storage, transport and/or handling.

The compositions set forth above can be formulated in any manner. Non-limiting formulation examples include but are not limited to, e.g., emulsifiable concentrates, wettable powders, liquids, aerosols, ultra-low volume concentrate solutions, soluble powders, microencapsulation, micro or nanoemulsions, etc. In any of the formulations of the present invention, the percent of the active ingredient(s) is within a range of 0.01% to 99.99%.

The compositions may be in a liquid, gel, powder, or solid form. In one non-limiting example, a solid composition can be prepared by mixing the active ingredient(s) and drying the suspension under mild conditions, such as evaporation at room temperature or vacuum evaporation at 65° C. or lower. In certain embodiments, the liquid can further includes a nucleating or other solid that encourages evaporation of the liquid to leave a solid.

In certain other non-limiting embodiments, the composition formed into a gel-encapsulated active ingredient(s). Such gel-encapsulated materials can be prepared by mixing a gel-forming agent (e.g., gelatin, cellulose, or lignin) with a culture or suspension of live or inactivated Bacillus amyloliquefaciens and/or Bacillus subtilis, or a cell-free filtrate or cell fraction of a Bacillus amyloliquefaciens and/or Bacillus subtilis culture or suspension, or a spray- or freeze-dried culture, cell, or cell fraction or in a solution of pesticidal compounds used in the method of the invention; and inducing gel formation of the agent.

To increase availability, solubility, stability, etc., the composition may additionally comprise a stabilizing agent such as a surfactant to form an emulsification, dispersion, wetting, spreading, integration, disintegration control, stabilization of active ingredients, and improvement of fluidity or rust inhibition. Generally, the stabilizing agent is a non-phytotoxic non-ionic surfactant which preferably belongs to EPA List 4B. The concentration of stabilizing agent may range between 0.1-35% of the total formulation, more particularly a range of 5-25%. The choice of dispersing and emulsifying agents, such as non-ionic, anionic, amphoteric and cationic dispersing and emulsifying agents, and the amount employed is determined by the nature of the composition and the ability of the agent to facilitate the dispersion of the compositions of the present invention.

The present invention includes compositions and method of using Bacillus amyloliquefaciens and/or Bacillus subtilis, including its whole broth metabolites, to control Goss or Stewart Wilt in fruits and plants infected with Goss Wilt (Clavibacter michiganensis) or Stewart Wilt (Pantoea stewartii (aka Erwinia stewartii)). The present invention provides novel methods for pre-treating seeds and plant crops prior to infection with Goss or Stewart Wilt, treatment post-infection, and prevention of reinfection. Stewart wilt can be a serious disease of many corn types, including: sweet, dent, flint, flower, and popcorn.

In one embodiment, the present invention achieves plant pathogen suppression by applying low pH organic acids and other anti-pathogen metabolites on either the infected seed and or the whole plant crop in combination with the bacteria, which continues to produce these metabolites. Application can be via the irrigation system, air spray delivery or mist application to seeds. The use of whole broth combines the fortitude of a locally-derived bacterial strain capable of competing in the environment with pre-existing secondary metabolites effective against the wilt disease, which provides a novel two-pronged approach to infection control. Because the original bacteria is found in nature and is generally regarded and safe (GRAS), the making of the compositions and methods of the present invention provides a novel and environmentally safe and responsible way to control the disease state of the crop. The broad spectrum suppression of plant pathogens exhibited by novel compositions of the present invention show the wide range of economically important crop varieties, which are susceptible to bacterial and fungal disease states that can benefit from the use of this invention. These include but are not limited to: corn, soybean, strawberry, and alfalfa.

The use of Bacillus amyloliquefaciens and or its closely related subspecies Bacillus subtilis (BABS) was used to control Goss Wilt and other bacterial and fungal disease states of crop plants by applying whole broth containing between 100,000 and 1×10¹² colony forming units per ton of whole live plant material. The invention can be used prophylactically to prevent the infection of disease state or on infected plants to suppress the progression of the disease. Application can be via: dilution into an irrigation system; whole broth concentrate application by plane or helicopter; mist or powdered freeze-dried application to seeds.

A single application of bacterial BABS broth containing ˜2×10⁸ CFU per acre was applied by spray plane to 250 acres of field corn with moderate to severe goss wilt infection and compared to 250 control acres of unsprayed corn with the same degree of infection. Note: Typical non-infected hybrid corn fields were expected to yield approximately 36 tons silage/acre or 225 bushels corn/acre.

Results: Upon application an immediate greening of leaves was observed within 7 days of application as compared to the control section. Final harvest yields resulted in a 10% increase in bushels of corn per acre compared to the control field.

Based on these results, it is also possible to: (1) increase application volumes and CFU per acre to infected fields; (2) apply multiple applications during growth stages; (3) apply the invention to high risk fields prior to observed infection; and (4) apply the product to seed in high risk fields.

Fermentation of BABS was achieved via a multistep scale up process starting with a single isolated master stock of BABS. The master stock was isolated in Weld County and Lamar County, Colorado from a healthy silage pit and is considered to be regionally specific where additional wild type plasmids enable to bacteria to compete in a natural environment. Confirmation of strains was achieved from Colorado State University using MALDI-TOF Mass Spectroscopy.

The master stock was first streaked on MRS agar plates and incubated for between 10 and 36 (e.g., 20) hours at between 25° C. and 35° C. (e.g., 32° C.). Upon colony formation, morphology and homogeneity is confirmed prior to inoculation of 1,000 ml shake flask containing 500 ml MRS sterile broth. The following amplification scheme is then conducted using stainless steel microbial agitated fermenters and aeration. Glucose and other related sugars along with micronutrients and lysates are used in a fed batch fermentation.

Likewise, Stewart Wilt was also studied. The use of Bacillus amyloliquefaciens and or its closely related subspecies Bacillus subtilis (BABS) was used to control Stewart Wilt. Using the present invention in an in vitro system, the present invention was able to stop the growth of Stewart wilt with a 100 mm zone of inhibition.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

What is claimed is:

1. A method for treating plants, grass, or organism for a phytopathogenic microorganism comprising:
identifying a plant or grass in need of treatment for Goss or Stewart Wilt; and
spraying the plant or grass with a cell suspension, supernatant, filtrate, cell fraction, or whole cell broth derived from at least one of Bacillus amyloliquefaciens, or Bacillus subtilis, effective to inhibit said phytopathogenic microorganisms.

2. The method of claim 1, wherein the cell suspension, supernatant, filtrate, cell fraction, or whole cell broth is a liquid, a gel, is dry, is ground, is extracted from both Bacillus amyloliquefaciens and Bacillus subtilis.

3. The method of claim 1, wherein the cell suspension, supernatant, filtrate, cell fraction, or whole cell broth is freeze-dried, heat dried, vacuum dried, air-dried, spray-dried and combinations thereof.

4. The method of claim 1, further comprising adding to the cell suspension, supernatant, filtrate, cell fraction, or whole cell broth: a stabilizer, anti-oxidant, a water-repellent, a UV absorbing agent, an anti-microbial agent, a carrier, a diluent, a surfactant, an adjuvant, and combinations thereof.

5. The method of claim 1, wherein a seed, a plant, a fruit, or a grass is coated in situ with the cell suspension, supernatant, filtrate, cell fraction, or whole cell broth.

6. The method of claim 1, wherein the cell suspension, supernatant, filtrate, cell fraction, or whole cell broth derived comprises cell content of at least 10⁸ Bacillus amyloliquefaciens and/or Bacillus subtilis per milliliter.

7. The method of claim 1, further comprising the step of heating the cell suspension, supernatant, filtrate, cell fraction, or whole cell broth prior to application.

8. The method of claim 1, wherein the plant treated comprises strawberry, squash, cucumber, tomato, rose, pepper eggplant, grapevine, cotton, onion, garlic, wheat, soy, corn and rice.

9. A composition pre-treating a plant, grass, or organism against Goss or Stewart Wilt comprising:
a cell suspension, supernatant, filtrate, cell fraction, or whole cell broth derived from at least one of Bacillus amyloliquefaciens, or Bacillus subtilis, effective to inhibit said phytopathogenic microorganisms, wherein the composition is adapted for delivery to the plant or grass and wherein the treated plant or grass has a lower infection rate of Goss or Stewart Wilt than an untreated plant.

10. The composition of claim 9, wherein the cell suspension, supernatant, filtrate, cell fraction, or whole cell broth is a liquid, a gel, is dry, is ground, is extracted from both Bacillus amyloliquefaciens and Bacillus subtilis.

11. The composition of claim 9, wherein the cell suspension, supernatant, filtrate, cell fraction, or whole cell broth is freeze-dried, heat dried, vacuum dried, air-dried, spray-dried and combinations thereof.

12. The composition of claim 9, further comprises: a stabilizer, anti-oxidant, a water-repellent, a UV absorbing agent, an anti-microbial agent, a carrier, a diluent, a surfactant, an adjuvant, or combinations thereof.

13. The composition of claim 9, wherein a seed, a plant, a fruit, or a grass is coated in situ with the cell suspension, supernatant, filtrate, cell fraction, or whole cell broth.

14. The composition of claim 9, wherein the cell suspension, supernatant, filtrate, cell fraction, or whole cell broth derived comprises cell content of at least 10⁸ Bacillus amyloliquefaciens, Bacillus subtilis, or both per milliliter.

15. The composition of claim 9, wherein the cell suspension, supernatant, filtrate, cell fraction, or whole cell broth is heated prior to application.

16. The composition of claim 9, wherein the cell suspension, supernatant, filtrate, cell fraction, or whole cell broth is adapted for administration to strawberry, squash, cucumber, tomato, rose, pepper eggplant, grapevine, cotton, onion, garlic, wheat, soy, corn and rice.

17. The composition of claim 9, wherein the cell suspension causes plant pathogen suppression by applying low pH organic acids and other anti-pathogen metabolites on either an infected seed and or a whole plant crop in combination with the bacteria, which continues to produce these metabolites.

18. A method for treating a plant or grass with a non-toxic, biodegradable composition comprising:
treating the plant with a cell suspension, supernatant, filtrate, cell fraction, or whole cell broth derived from at least one of Bacillus amyloliquefaciens, or Bacillus subtilis, wherein the composition treats or eliminates a least 10 percent of the effects from Goss or Stewart Wilt when compared to a non-treated plant.

19. The method of claim 18, wherein the cell suspension, supernatant, filtrate, cell fraction, or whole cell broth is a liquid, a gel, is dry, is ground, is extracted from both Bacillus amyloliquefaciens and Bacillus subtilis.

20. The method of claim 18, wherein the cell suspension, supernatant, filtrate, cell fraction, or whole cell broth is freeze-dried, heat dried, vacuum dried, air-dried, spray-dried and combinations thereof.

21. The method of claim 18, further comprising adding to the cell suspension, supernatant, filtrate, cell fraction, or whole cell broth: a stabilizer, anti-oxidant, a water-repellent, a UV absorbing agent, an anti-microbial agent, a carrier, a diluent, a surfactant, an adjuvant, and combinations thereof.

22. The method of claim 18, wherein a seed, a plant, a fruit, or a grass is coated in situ with the cell suspension, supernatant, filtrate, cell fraction, or whole cell broth.

23. The method of claim 18, wherein the cell suspension, supernatant, filtrate, cell fraction, or whole cell broth derived comprises cell content of at least 10⁸ Bacillus amyloliquefaciens and/or Bacillus subtilis per milliliter.

24. The method of claim 18, further comprising the step of heating the cell suspension, supernatant, filtrate, cell fraction, or whole cell broth prior to application.

25. The method of claim 18, wherein the plant treated comprises strawberry, squash, cucumber, tomato, rose, pepper eggplant, grapevine, cotton, onion, garlic, wheat, soy, corn and rice.

26. The method of claim 18, wherein the plant comprises a fruit or vegetable and wherein the fruit or vegetable has an increase in the size and number of fruit or vegetable size, fruit or vegetable number and combinations thereof.

27. The method of claim 18, wherein the cell suspension or whole cell broth causes plant pathogen suppression by applying low pH organic acids and other anti-pathogen metabolites on either an infected seed and or a whole plant crop in combination with the bacteria, which continues to produce these metabolites.

28. A method of inhibiting one or more phytopathogenic microorganisms in a location comprising introducing into the location an amount of a cell suspension, supernatant, filtrate, cell fraction, or whole cell broth derived from a cell suspension, supernatant, filtrate, cell fraction, or whole cell broth derived from a Bacillus amyloliquefaciens and/or Bacillus subtilis, effective to inhibit said phytopathogenic microorganisms; wherein the location is in the soil, seed, or residual organic material and said one or more phytopathogenic microorganisms is Clavibacter michiganensis or Pantoea stewartia.

29. The method of claim 28, further comprising introducing another anti-microbial agent into the location.

30. The method of claim 28, wherein the location comprises plant parts.
